(19) United States
(12) Patent Application Publication
(10) Pub. No.: US 2010/0189085 A1
(43) Pub. Date: Jul. 29, 2010

(54) METHOD AND SYSTEM FOR HIGH RELIABILITY DELIVERY OF CONTENT TO A PLURALITY OF USERS VIA A PLURALITY OF FEMTOCELLS

(76) Inventors: Mark Kent, Vista, CA (US); Charles Abraham, Los Gatos, CA (US); Xuemin (Sherman) Chen, San Diego, CA (US); Wael William Diab, San Francisco, CA (US); Vinko Erceg, Cardiff, CA (US); Victor Hou, LaJolla, CA (US); Jeyhan Karaoguz, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/361,391

(22) Filed: Jan. 28, 2009

(51) Int. Cl. H04W 84/02

(52) U.S. Cl. 370/338

(57) ABSTRACT

A cellular enabled device may be operable to receive replicas of content that are communicated from a plurality of femtocells via transmit diversity. The content may comprise voice, video and/or data. A location of the cellular enabled device may be determined and/or communicated to each of the plurality of femtocells. Synchronization may enable the transmission of the content replicas based on the location of the cellular enabled device. Transmission times of the content replicas may be adjusted based on a location of the cellular enabled device. Transmission power and/or gain of the content replicas that are transmitted from each of the plurality of femtocells may be adjusted based on the location of the cellular enabled device. The content replicas may be received via different ones of a plurality of wireless communication standards.

### CROSS-REFERENCE TO RELATED APPLICATIONS/INCORPORATION BY REFERENCE

Not applicable.

### FIELD OF THE INVENTION

Certain embodiments of the invention relate to communications. More specifically, certain embodiments of the invention relate to a method and system for high reliability delivery of content to a plurality of users via a plurality of femtocells.

### BACKGROUND OF THE INVENTION

A femtocell may be placed in a customer's residence or in a small business environment, for example. Femtocells may be utilized for off-loading macro radio network traffic, improving coverage locally in a cost-effective manner, and/or implementing home-zone services to increase revenue. Femtocells, like macro cell base stations, may be enabled to connect “standard” phones to a cellular provider's network by a physical broadband connection which may be a digital subscriber line (DSL) connection and/or a cable connection, for example. Since the traffic between a customer's premises femtocell equipment and the operator's network may be traversing a public network, the traffic may be prone to various risks.

Communication between femtocells and one or more cellular provider's networks enables operation in private and public areas. The capacity of a femtocell may be adequate to address a typical family use model supporting two to four simultaneous voice calls and/or data traffic, for example.

An important characteristic of femtocells is their ability to control access. In an open access scenario, any terminal and/or subscriber may be allowed to communicate with the femtocell. Accordingly, the femtocell usage may somewhat resemble that of a macrocell system. In a closed access scenario, the femtocell may serve a limited number of terminals and/or subscribers that may be subscribed to a given cellular base station. In this regard, the cellular base station may be perceived as being deployed for private usage.

A regulatory issue with regard to femtocells is that they use licensed frequencies that radiate at a very low power in a controlled environment. It may be likely that they may not require a license from a local authority, as macrocell base stations do. An additional regulatory issue may arise from the relationship between a femtocell operator and a broadband services operator. One possible scenario may include the broadband operator being unaware of the existence of a femtocell operator. Conversely, the broadband operator and femtocell operator may have an agreement or they may be the same operator, for example. Interference between femtocells may be an issue for femtocell deployments based on wideband technologies such as WCDMA, for example, because initial operator deployments may use the same frequency for both the femtocell and the macrocell networks or due to the proximity of femtocell base stations in dense urban areas.

There are a plurality of design models for deployment and integration of femtocells, for example, an IP based Iu-b interface, a session initiation protocol (SIP) based approach using an Iu/A interface, use of unlicensed spectrum in a technique known as unlicensed mobile access (UMA) and/or use of IP multimedia subsystem (IMS) voice call continuity (VCC), for example.

In an Iu-b model based femtocell deployment approach, femtocells may be fully integrated into the wireless carrier's network and may be treated like any other remote node in a network. The Iu-b protocol may have a plurality of responsibilities, such as the management of common channels, common resources, and radio links along with configuration management, including cell configuration management, measurement handling and control, time division duplex (TDD) synchronization, and/or error reporting, for example. In Iu-b configurations, mobile devices may access the network and its services via the Node B link, and femtocells may be treated as traditional base stations.

In a SIP based femtocell deployment approach, a SIP client, embedded in the femtocell may be enabled to utilize SIP to communicate with the SIP-enabled mobile switching center (MSC). The MSC may perform the operational translation between the IP SIP network and the traditional mobile network, for example.

In a UMA based femtocell deployment approach, a generic access network (GAN) may offer an alternative way to access GSM and GPRS core network services over broadband. To support this approach, a UMA Network Controller (UNC) and protocols that guarantee secure transport of signaling and user traffic over IP may be utilized. The UNC may be enabled to interface into a core network via existing 3GPP interfaces, for example, to support core network integration of femtocell based services by delivering a standards based, scalable IP interface for mobile core networks.

In an IMS VCC based femtocell deployment approach, VCC may provide for a network design that may extend an IMS network to include cellular coverage and address the handoff process. The IMS VCC may be designed to provide seamless call continuity between cellular networks and any network that supports VoIP, for example. The VCC may also provide for interoperability between GSM, UMTS, and CDMA cellular networks and any IP capable wireless access network, for example. The IMS VCC may also support the use of a single phone number or SIP identity and may offer a broad collection of functional advantages, for example, support for multiple markets and market segments, provisioning of enhanced IMS multimedia services, including greater service personalization and control, seamless handoff between circuit-switched and IMS networks, and/or access to services from any IP device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for high reliability delivery of content to a plurality of users via a plurality of femtocells, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an exemplary cellular network, in accordance with an embodiment of the invention.

FIG. 1B is a diagram illustrating communication with a cellular network comprising a femtocell, in accordance with an embodiment of the invention.

FIG. 1C is a diagram illustrating an exemplary block diagram of a femtocell, in accordance with an embodiment of the invention.

FIG. 1D is a block diagram of an exemplary cellular enabled device, in accordance with an embodiment of the invention.

FIG. 1E is a block diagram of an exemplary cellular device operable to communicate based on a plurality of wireless communication standards, in accordance with an embodiment of the invention.

FIG. 2A is a diagram illustrating a plurality of femtocells transmitting the same information with transmit diversity to a single cellular enabled device, in accordance with an embodiment of the invention.

FIG. 2B is a diagram illustrating a plurality of femtocells communicating with transmit diversity to a plurality of cellular enabled devices, in accordance with an embodiment of the invention.

FIG. 3 illustrates exemplary steps for communicating the same information from two femtocells to a single cellular enabled device, in accordance with an embodiment of the invention.

### DETAILED DESCRIPTION OF THE INVENTION

Certain embodiments of the invention may be found in a method and system for high reliability delivery of content to a plurality of users via a plurality of femtocells. In various embodiments of the invention, a cellular enabled device may be operable to receive replicas of content communicated from a plurality of femtocells. The replicas of the content may be transmitted by the plurality of femtocells via transmit diversity wherein the content may comprise voice, video and/or data. In various embodiments of the invention, a location of the cellular enabled device may be determined and/or communicated to each of the plurality of femtocells. The femtocells may be synchronized to enable the transmission of the content replicas based on the location of the cellular enabled device. In this manner, transmission times of the content replicas may be adjusted based on a location of the cellular enabled device. For example, the transmission times may be adjusted so that signals comprising the replicated content may combine coherently “over the air’ or within the cellular enabled device. Furthermore, the power and/or gain of the content replicas that are transmitted from each of the plurality of femtocells may be adjusted based on the location of the cellular enabled device. In various embodiments of the invention, the content replicas may be received via different ones of a plurality of wireless communication standards.

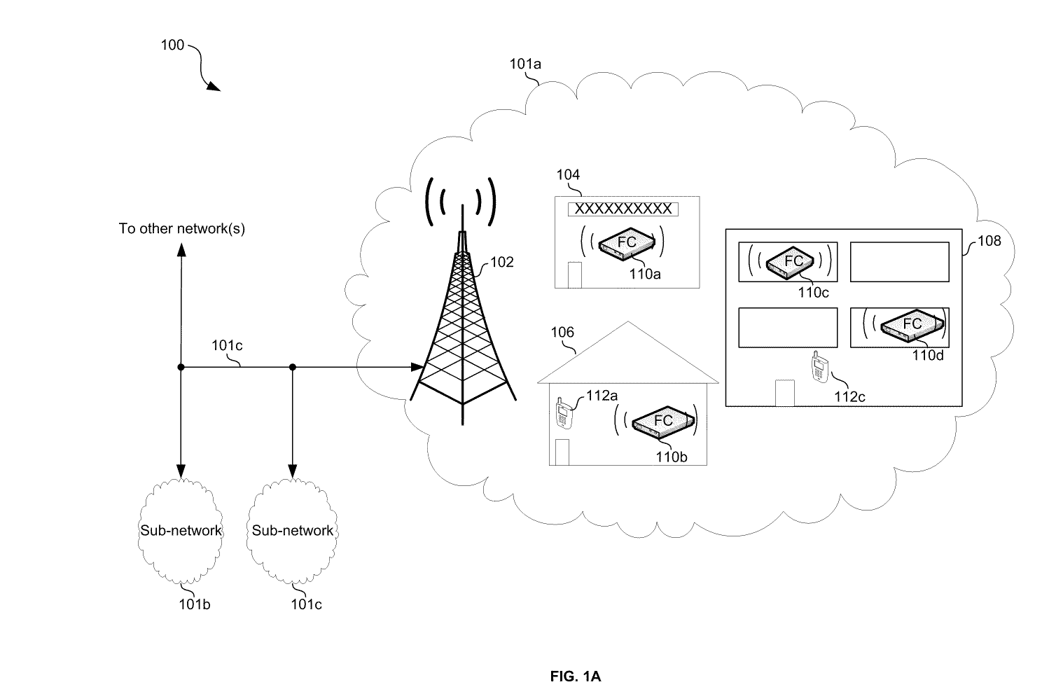

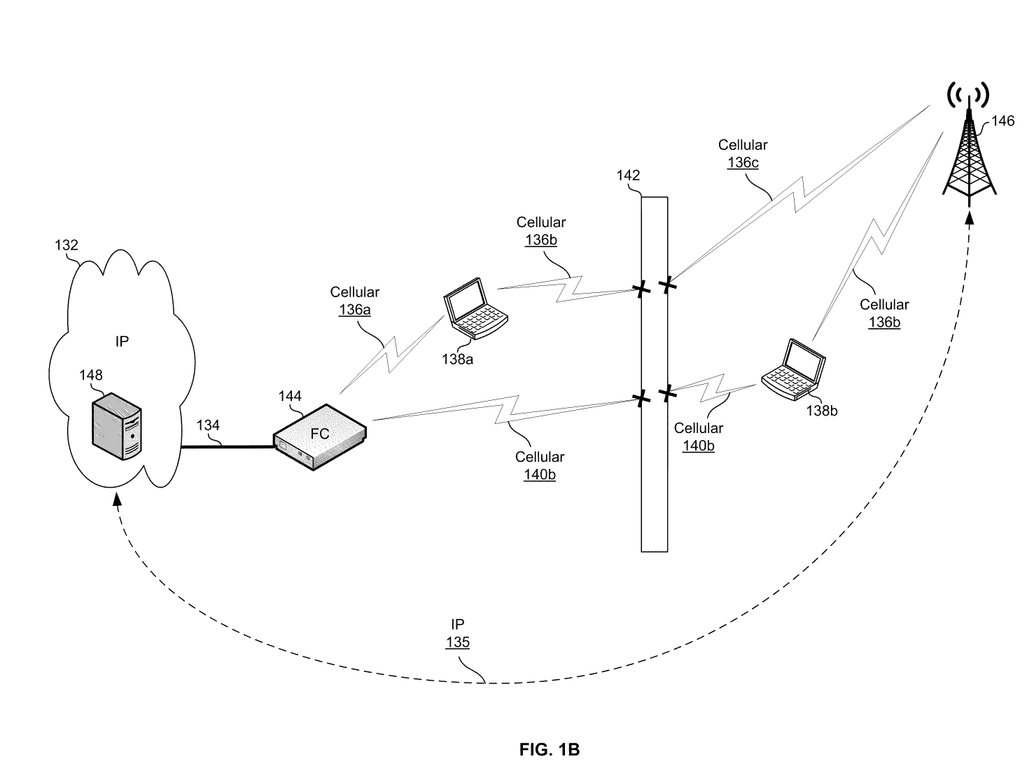

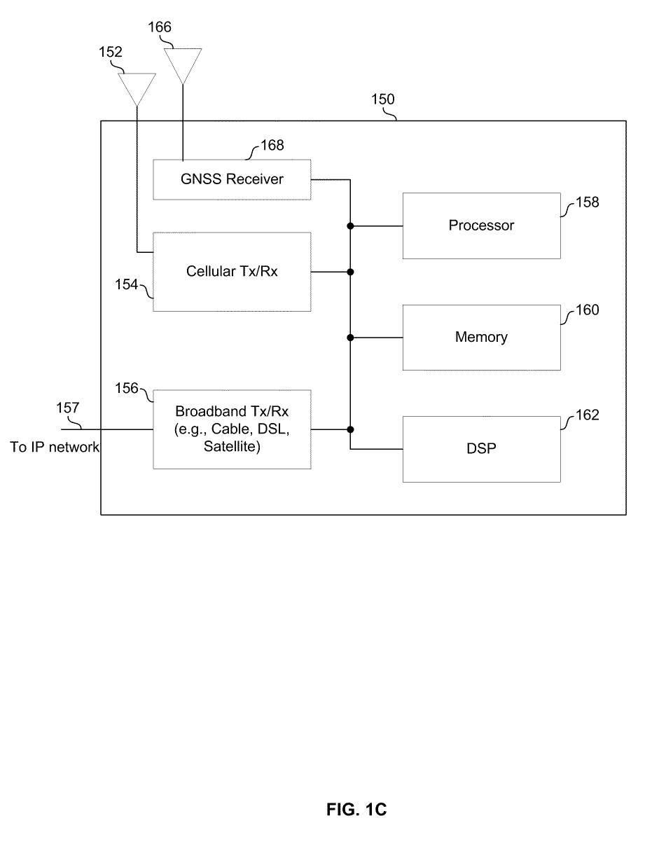

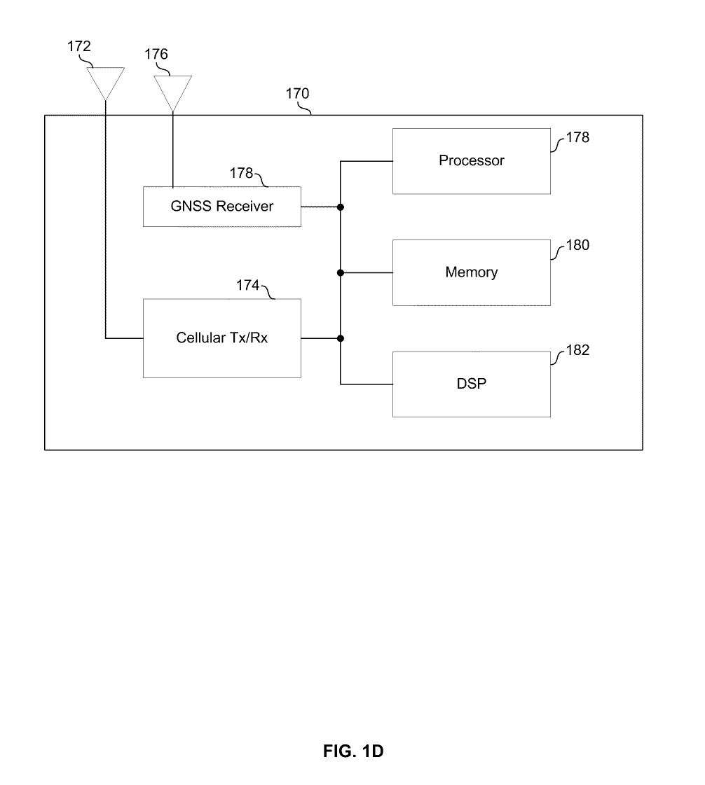

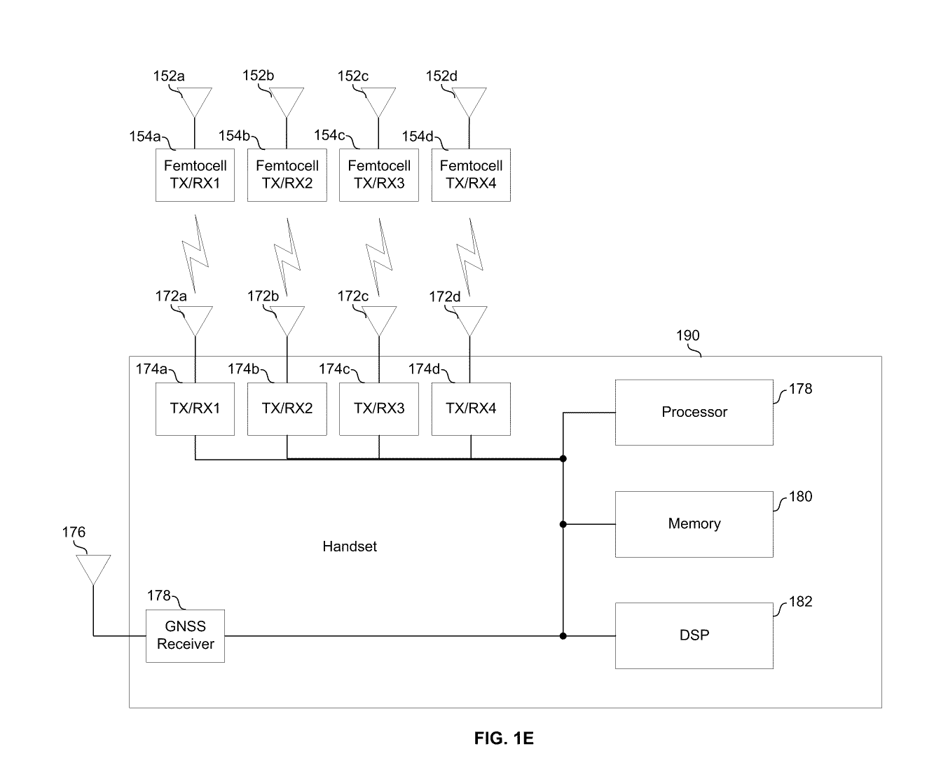

FIG. 1A is a diagram illustrating an exemplary cellular network, in accordance with an embodiment of the invention. Referring to FIG. 1A, there is shown a cellular network 100 comprising sub-networks 101a-101c. The exemplary sub-network 101a may comprise a base station 102, femtocells 110a-110d, which are collectively referred to herein as femtocells 110, and cellular enabled devices 112a and 112c, which are collectively referred to herein as cellular enabled devices 112. The femtocells 110 may be installed in one or more commercial properties 104, one or more residential properties 106, and/or one or more multi-tenant properties 108.

The commercial properties 104 may comprise, for example, stores, restaurants, offices, and municipal buildings. The residential properties 106 may comprise, for example, single-family homes, home offices, and/or town-houses. Multi-tenant properties 108 may comprise residential and/or commercial tenants such as apartments, condos, hotels, and/or high rises.

The base station 102 may be operable to communicate data wirelessly utilizing one or more cellular standards such as IS-95, CDMA, GSM, TDMA, GPRS, EDGE, UMTS/WCDMA, TD-SCDMA, HSDPA, extensions thereto, and/or variants thereof. “Data,” as utilized herein, may refer to any analog and/or digital information including but not limited to voice, Internet data, and/or multimedia content. Multimedia content may comprise audio and/or visual content comprising, video, still images, animated images, and/or textual content. The base station 102 may communicate with cellular enabled devices such as the cellular enabled devices 112. Exemplary cellular standards supported by the base station 102 may be specified in the International Mobile Telecommunications-2000 (IMT-2000) standard and/or developed by the 3^{rd} generation partnership project (3GPP) and/or the 3^{rd} generation partnership project 2 (3GPP2). The base station 102 may communicate data amongst the various components of the sub-network 101a. Additionally, data communicated to and/or from the base station 102 may be communicated to sub-network 101b, sub-network 101c, and/or to one or more other networks (not shown) via one or more backhaul links 103. In this manner, data communicated to and/or from the base station 102 may be communicated to and/or from, other portions of the network 100 and/or other networks. Exemplary networks with which data may be communicated may comprise public switched telephone networks (PSTN) and/or IP networks such as the Internet or an intranet.

The femtocells 110 may each comprise suitable logic, circuitry, and/or code that may be operable to communicate wirelessly utilizing one or more cellular standards such as IS-95, CDMA, GSM, TDMA, GPRS, EDGE, UMTS/WCDMA, TD-SCDMA, HSDPA, extensions thereto, and/or variants thereof. In this regard, the femtocells 110 may each communicate with cellular enabled devices such as the cellular enabled devices 112. Exemplary cellular standards supported by the femtocells 110 may be specified in the International Mobile Telecommunications-2000 (IMT-2000) standard and/or developed by the 3^{rd} generation partnership project (3GPP) and/or the 3^{rd} generation partnership project 2 (3GPP2). Additionally, the femtocells 110 may each comprise suitable logic, circuitry, and/or code that may be operable to communicate over an IP network (not shown in FIG. 1A). In various embodiments of the invention the femtocells 110, the sub-network 101c, and/or the network 100 may be managed by a service provider which licenses the cellular frequencies utilized. In this regard, the service provider may enable a plurality of femtocells to communicate simultaneously with a single cellular enabled device. For example, the femtocell 110c and the femtocell 110d may be enabled to communicate simultaneously with the cellular enabled device 112c. Furthermore, one or more femtocells and one or more macrocells may be operable to simultaneously communicate the same information to a single cellular enabled device. For example, the base station 102 and the femtocell 110b may simultaneously communicate the same information to the cellular enabled device 110b.

The cellular enabled devices 112 may each comprise suitable logic, circuitry, and/or code that may be operable to communicate utilizing one or more cellular standards. In this regard, the cellular enabled devices 112 may each be operable to transmit and/or receive data via the cellular network 100. Exemplary cellular enabled device may comprise laptop computers, mobile phones, and personal media players. The cellular enabled devices 112 may be enabled to receive, process, and present multimedia content and may additionally be enabled run a web browser or other applications for providing Internet services to a user of the cellular enabled device 112. In various embodiments of the invention, the cellular enabled devices 112 may be operable to communicate simultaneously with a plurality of femtocells. For example, the cellular enabled device 112c may be enabled to communicate simultaneously with the femtocell 110c and the femtocell 110d.

In operation, the cellular enabled devices 112 may gain access to the cellular network 100 and/or to other communication networks via cellular communications with the base station 102 and the femtocells 110. In this regard, in instances that a reliable connection may be established between the base station 102 and a cellular enabled device 112, then data may be communicated between the cellular enabled device 112 and the base station 102. Alternatively, in instances that a reliable connection may be established between a femtocell 110 and a cellular enabled device 112, then data may be communicated between the cellular enabled device 112 and the femtocell 110. Accordingly, the femtocells 110 may extend the cellular coverage area in the sub-network 101a. In particular, the femtocells 110 may extend or improve cellular coverage indoors or to locations out of range of a base-station.

In instances that a cellular enabled device communicates via a femtocell, the parameters of the communication channel(s) between the femtocell and the cellular enabled device may be controlled based on feedback, control, and/or management messages exchanged over a broadband connection between a femtocell 110 and a network management entity. Exemplary parameters may comprise a round trip path delay, data rate of the channel, a modulation scheme of the channel, error coding schemes utilized for the channel, and transmitted power levels. Exemplary feedback may comprise received signal strength information at the femtocell, received signal strength information at the cellular enabled device, measured interference at the femtocell, measured interference at the cellular enabled device, bit error rates at the femtocell, bit error rates at the cellular enabled device, timing information and/or location of the cellular enabled device and/or the femtocell (e.g., Global navigation satellite system (GNSS) timing and/or location coordinates), available bandwidth of the femtocell, and/or available bandwidth of the cellular enabled device. Additionally, feedback from a cellular enabled device may indicate the capabilities of that device. Exemplary capabilities which may be communicated may comprise a hardware configuration, a software configuration, maximum transmit power, and battery strength.

In various embodiments of the invention, the plurality of femtocells may communicate with a cellular enabled device. For example, the femtocells 110c and 100d may communicate replicas of the same content to the cellular enabled device 112c. In this regard, the femtocells 110c and 110d may be synchronized and may communicate based on the feedback, control, and/or management messages.

FIG. 1B is a diagram illustrating communication with a cellular network comprising a femtocell, in accordance with an embodiment of the invention. Referring to FIG. 1B, there is shown a femtocell 144, cellular enabled devices 138a and 138b (collectively referred to herein as cellular enabled devices 138), communication barrier 142, and base station 146. The femtocell 144 may be communicatively coupled to an IP network 132 via a connection 134.

The base station 146 may be similar to or the same as the base station 102 described with respect to FIG. 1B. The cellular enabled devices 138 may be similar to or the same as the cellular enabled devices 112 described with respect to FIG. 1A. The femtocell 144 may be similar to or the same as the femtocells 110 described with respect to FIG. 1A.

The IP network 132 may comprise one or more network devices and/or network links operable to transmit and/or receive IP packets. The IP network 132 may provide access to the Internet and/or one or more private networks.

The network management entity 148 may comprise one or more servers and/or computing devices which may manage communication with one or more cellular enabled devices, for example, cellular enabled device 138a via one or more femtocells, for example the femtocell 144. The management entity 148 and the femtocell 144 may communicate utilizing IP via the connection 134. In various embodiments of the invention, the network management entity 148 may coordinate operation of the femtocell 144 and one or more other femtocells to enable communication between a plurality of femtocells and a single cellular enabled device 138a.

The connection 134 may comprise a broadband connection such as a digital subscriber line (DSL), Ethernet, passive optical network (PON), a T1/E1 line, a cable television infrastructure, a satellite television infrastructure, and/or a satellite broadband Internet connection. The connection 134 may comprise one or more optical, wired, and/or wireless links.

The communications barrier 142 may comprise an obstruction to cellular communications. In some instances, the barrier 142 may comprise a physical barrier such as a building or mountainous terrain. In some instances, the barrier 142 may represent a distance which may be too great for reliable cellular communications. In some instances, the barrier 142 may represent interference or a limitation of channel capacity which may prevent cellular communications. The barrier 142 may prevent cellular communications between the base station 146 and the cellular enabled device 138a and may prevent cellular communications between the femtocell 144 and the cellular enabled device 138b.

In operation, the cellular enabled device 138a and the cellular enabled device 138b may communicate via the femtocell 144, the base station 146, and the IP network 132. For example, the cellular enabled device 138a may transmit data to the femtocell 144 utilizing one or more cellular standards. In various embodiments of the invention, communication via the channel 136a between the femtocell 144 and the cellular enabled device 138a may be managed by the network management entity 148. The femtocell 144 may packetize the data into one or more IP packets and the IP packets may be further encapsulated, encoded, modulated, or otherwise processed. The IP packets may then be routed via the IP network 132 and/or various other networks (not shown) to the base station 146. In some instances, the base station 146 may utilize IP backloading and the IP packets may be conveyed to the base station 146. In other instances, the IP packets may be transcoded via one or more network elements (not shown) to a format supported by the base station 146. The data may then be extracted from the IP packets, transcoded to a format suitable for cellular transmission and subsequently transmitted to the cellular enabled device 138b. In this manner, the femtocell 144 and/or management entity 148 may enable communication between the cellular enabled device 138a and the cellular enabled device 138b via the cellular base station 146 however, the invention is not so limited. In various embodiments of the invention, the femtocell 144 and/or management entity 148 may enable communication between the cellular enabled device 138a and a communication device that is not cellular enabled, for example, a LAN, WiFi and/or WLAN enabled device.

Although, FIG. 1B describes communication between a pair of cellular enabled devices via a single femtocell and a base station, communication with other equipment via one or more femtocells and an IP network may be similar to the communication described with respect to FIG. 1B. In this regard, devices which may communicate via one or more femtocells may comprise cellular enabled devices in other sub-networks, cellular enabled devices in different cellular networks, conventional “landline” phones coupled to a PSTN, IP phones, and computing devices such as PCs and fileservers coupled to an IP network.

FIG. 1C is a diagram illustrating an exemplary block diagram of a femtocell, in accordance with an embodiment of the invention. Referring to FIG. 1C, there is shown a femtocell 150 comprising an antenna 152, a cellular transmitter and/or receiver (Tx/Rx) 154, a broadband transmitter and/or receiver (Tx/Rx) 156, a processor 158, a memory 160, a digital signal processor (DSP) 162, the global navigation satellite system (GNSS) receiver 168 and the GNSS antenna 166. The femtocell 150 may be similar to or the same as the femtocells 110 described with respect to FIG. 1A and/or the femtocell 144 described with respect to FIG. 1B.

The GNSS receiver 168 and GNSS antenna 166 comprise suitable logic, circuitry and/or code to receive signals from one or more GNSS satellites, for example, GPS satellites. The received signals may comprise timing, ephemeris and/or almanac information that enable the GNSS receiver 168 to determine its location and/or time.

The antenna 152 may be suitable for transmitting and/or receiving cellular signals. Although a single antenna is illustrated, the invention is not so limited. In this regard, the cellular Tx/Rx 154 may utilize a common antenna for transmission and reception, may utilize different antennas for transmission and reception, and/or may utilize a plurality of antennas for transmission and/or reception.

The cellular Tx/Rx 154 may comprise suitable logic circuitry and/or code that may be operable to transmit and/or receive voice and/or data utilizing one or more cellular standards. The cellular Tx/Rx 154 may be operable to perform amplification, down-conversion, filtering, demodulation, and analog to digital conversion of received cellular signals. The cellular Tx/Rx 154 may be operable to perform amplification, up-conversion, filtering, modulation, and digital to analog conversion of transmitted cellular signals. The cellular Tx/Rx 154 may support communication over a plurality of communication channels utilizing time division multiple access (TDMA) and/or code division multiple access (CDMA). Exemplary cellular standards supported by the femtocells 110 may be specified in the International Mobile Telecommunications-2000 (IMT-2000) standard and/or developed by the 3^{rd} generation partnership project (3GPP) and/or the 3^{rd} generation partnership project 2 (3GPP2). In various embodiments of the invention, the cellular Tx/Rx 154 may be enabled to measure received signal strength. Additionally, the cellular Tx/Rx 154 may be enabled to adjust a power level and/or a modulation scheme or level of transmitted signals.

In various embodiments of the invention, the cellular Tx/Rx 154 may be operable to measure round trip path delay between the femtocell 150 and a cellular enabled device that it may be communicating with. In addition, global navigation satellite system (GNSS) data may be utilized to determine path delay and/or path distance between the femtocell 150 and the cellular enabled device. For example, timing information from the GNSS satellite system may be utilized as a timing reference for one or more femtocells and/or one or more cellular enabled devices. The GNSS timing reference may enable path delay measurements for signals communicated between the one or more femtocells and the cellular enabled device 150.

The cellular Tx/Rx 154 may be operable to transmit signals in coordination with one or more other femtocells. For example, a plurality of femtocells may be synchronized so that signal transmissions comprising the same information may be transmitted to a single cellular enabled device for example, the cellular enabled device 112c described with respect to FIG. 1. In this regard, transmissions from the plurality of femtocells may be coordinated and/or scheduled such that signals from the synchronized plurality of femtocells may constructively combine upon reception by the single cellular enabled device. Furthermore, the plurality of synchronized femtocells may each adjust the instant of transmission of signals such that the signals arriving via different path lengths may be coherently combined within the receiver of the single cellular enabled device. Moreover, the plurality of femtocells may be operable to adjust transmission signal power levels to enable improved reception and/or combining of the plurality of signals received at the single cellular enabled device. In this regard, the plurality of femtocells may transmit signals to the single cellular enabled device at a lower power level than single femtocell.

The broadband Tx/Rx 156 may comprise suitable logic, circuitry, and/or code that may be operable to transmit voice and/or data in adherence to one or more broadband standards. The broadband Tx/Rx 156 may be operable to perform amplification, down-conversion, filtering, demodulation, and analog to digital conversion of received signals. The broadband Tx/Rx 156 may be operable to perform amplification, up-conversion, filtering, modulation, and digital to analog conversion of transmitted signals. In various exemplary embodiments of the invention, the broadband Tx/Rx 156 may transmit and/or receive voice and/or data over the link 157 which may comprise, for example, a T1/E1 line, PON, DSL, cable television infrastructure, satellite broadband internet connection, satellite television infrastructure, and/or Ethernet.

The processor 158 may comprise suitable logic, circuitry, and/or code that may enable processing data and/or controlling operations of the femtocell 150. In this regard, the processor 158 may be enabled to provide control signals to the various other blocks comprising the femtocell 150. The processor 158 may also control data transfers between various portions of the femtocell 150. Additionally, the processor 158 may enable execution of applications programs and/or code. In various embodiments of the invention, the applications, programs, and/or code may enable, for example, parsing, transcoding, or otherwise processing data. In various embodiments of the invention, the applications, programs, and/or code may enable, for example, configuring or controlling operation of the cellular transmitter and/or receiver 154, the broadband transmitter and/or receiver 156, the DSP 162, and/or the memory 160. In various embodiments of the invention, the processor 158 may be enabled to provide one or more signals to the cellular Tx/Rx 154, the memory 160, and/or the DSP 162 to control parameters such as power level, modulation scheme, error coding scheme, and/or data rates of transmitted cellular signals.

The memory 160 may comprise suitable logic, circuitry, and/or code that may enable storage or programming of information that includes parameters and/or code that may effectuate the operation of the femtocell 150. The parameters may comprise configuration data and the code may comprise operational code such as software and/or firmware, but the information need not be limited in this regard. Moreover, the parameters may include adaptive filter and/or block coefficients. Additionally, the memory 160 may buffer or otherwise store received data and/or data to be transmitted. In various embodiments of the invention, the memory 150 may comprise one or more look-up tables which may be utilized for determining cellular devices within a coverage area of the femtocell 150.

The DSP 162 may comprise suitable logic, circuitry, and/or code operable to perform computationally intensive processing of data. In various embodiments of the invention, the DSP 162 may encode, decode, modulate, demodulate, encrypt, decrypt, scramble, descramble, and/or otherwise process data. In various embodiments of the invention, the DSP 162 may be enabled adjust a modulation scheme, error coding scheme, and/or data rates of transmitted cellular signals data.

In operation, the cellular Tx/Rx 154 may determine characteristics such as interference levels and signal strength of desired signals received via a cellular communication channel. Similarly, the DSP 162 and/or the processor 156 may determine bit error rates of data received via a cellular communication channel and available bandwidth of the channel. The measurements may be communicated to a network management entity by the Broadband Tx/Rx 156 via the link 157. Additionally, the femtocell 150 may receive feedback from a cellular enabled device on the other end of a cellular communication channel; that feedback may also be communicated to a central management entity by the Broadband Tx/Rx 156 via the link 157.

The Broadband Tx/Rx 156 may also receive network management messages from the central management entity. The processor 158 may utilize the received management messages to configure the cellular Tx/Rx 154 and/or the DSP 162 to control parameters of the communication channel such as transmitted cellular signal strength, error coding scheme for transmitted cellular signals, data rates for transmitted cellular signals, and modulation scheme for transmitted signals. Additionally, management messages may be relayed to the cellular enabled device via the cellular Tx/Rx 154. Based on various measurements and/or conditions, it may be determined that a plurality of wireless communication links may be established from a plurality of femtocells to one cellular enabled device wherein the plurality of communication links carry the same information. In various embodiments of the invention, a plurality of femtocells may routinely transmit and/or receive the same information to and/or from the same cellular enabled device.

FIG. 1D is a block diagram of an exemplary cellular enabled device, in accordance with an embodiment of the invention. The cellular enabled device 170 may comprise a cellular Tx/Rx 174, a cellular antenna 172, a global navigation satellite system (GNSS) receiver 178, a GNSS antenna 176, a processor 178, a memory 180, and a DSP 182. The cellular enabled device 170 may be similar or the same as the cellular enabled device 112 described with respect to FIG. 1A and/or the cellular enabled device 138 described with respect to FIG. 1B. The GNSS receiver 178 and GNSS antenna 176 may be similar or the same as the GNSS receiver 168 and GNSS antenna 166 described with respect to FIG. 1C.

The processor 178 may be similar to or the same as the processor 158 described with respect to FIG. 1C. The memory 180 may be similar to or the same as the memory 160 described with respect to FIG. 1C. The DSP 182 may be similar to or the same as the DSP 162 described with respect to FIG. 1C. The global navigation satellite system (GNSS) receiver 168 and the GNSS antenna 166 are described with respect to FIG. 1C.

The cellular Tx/Rx 174 may be similar to or the same as the cellular Tx/Rx 154 described with respect to FIG. 1C. In various embodiments of the invention, the cellular Tx/Rx 174 may comprise a rake receiver that may combine signals received from a plurality of femtocells. In this regard, the rake receiver may combine signals that are received within a specified delay spread from one or more femtocells. In other embodiments of the invention, synchronized signal transmissions from a plurality of femtocells that are received by the cellular Tx/Rx 174 via the cellular antenna 172, may constructively combine such that a more robust signal is received. In this regard, the plurality of femtocells may be enabled to lower their transmission power levels.

In various embodiments of the invention, the cellular enabled device 150 may be a multimode wireless device and may comprise a plurality of diverse cellular transmitters and/or receivers (Tx/Rx). In this regard, the cellular enabled device 150 may be operable to receive signals comprising the same information from one or more femtocells that may utilize different wireless standards. The cellular enabled device 150 may be operable to select portions of information and/or combine information from the plurality of received signals based on the quality of received information and/or the quality of the received signal.

In operation, the cellular Tx/Rx 174 may determine interference levels and/or received signal strength for cellular communication channels over which it communicates. Similarly, the DSP 182 and/or the processor 176 may determine a data rate and/or a bit error rate of data received via cellular communication channels over which it communicates. The determinations may be communicated to a femtocell via a cellular communication channel. In addition, the determinations may enable transmit diversity communication on the forward link from a plurality of femtocells and/or receive diversity on the reverse link from the cellular enabled device 170 to a plurality of femtocells.

The cellular enabled device 170 may also receive, via the femtocell, control and/or management messages from a network management entity that may support the transmit diversity on the forward link and/or receive diversity on the reverse link. The processor 178 may utilize the received control and/or management messages to configure, for example, the cellular Tx/Rx 154 and/or the DSP 162 to control parameters such as transmitted cellular signal strength, error coding scheme for transmitted cellular signals, data rates for transmitted cellular signals, and modulation scheme for transmitted signals.

The cellular enabled device 170 may be operable to communicate simultaneously with one or more femtocells the on the same call and/or communication session. In this regard, the same information may be received by the cellular enabled device 170 from the one or more femtocells that may result in improvements in operating performance. In various embodiments of the invention, the cellular enabled device 170 may establish a call and/or session with the one or more femtocells in parallel. Alternatively, the cellular enabled device 170 may first establish a call and/or session with one of the femtocells and the other femtocell may be added to the established call and/or session at a later time. For example, a second femtocell may be added to a call when the cellular enabled device 170 enters into its serving area.

FIG. 1E is a block diagram of an exemplary cellular enabled device operable to communicate based on a plurality of wireless communication standards, in accordance with an embodiment of the invention. Referring to FIG. 1E, there is shown, a cellular enabled device 190 that may comprise cellular Tx/Rx 174a, 174b, 174c and 174d and corresponding cellular antennas 172a, 172b, 172c and 172c global navigation satellite system (GNSS) receiver 178, a GNSS antenna 176, the processor 178, the memory 180, and the DSP 182. In addition, there are four femtocell Tx/Rx 154a, 154b, 154c and 154d and four corresponding femtocell antennas 152a, 152b, 152c and 152d.

The Tx/Rx 174a, 174b, 174b 174c and 174d corresponding cellular antennas 172a, 172b, 172c and 172d may be similar and/or substantially the same as the Tx/Rx 174 and cellular antenna 142 described with respect to FIG. 1D. In addition, the global navigation satellite system (GNSS) receiver 178, a GNSS antenna 176, the processor 178, the memory 180, and the DSP 182 are described with respect to FIG. 1D. The Tx/Rx 154a, 154b, 154c and 154d and the corresponding femtocell antennas 152a, 152b, 152c and 152d may be similar and/or substantially the same as the Tx/Rx 154 and the femtocell antenna 152 respectively described with respect to FIG. 1C.

The cellular enabled device 190 may be similar to the cellular enabled device 170. However, the cellular enabled device 190 may be a multimode cellular enabled device that may be operable to communicate via four wireless communication standards, for example. Exemplary wireless communication standards comprise 3GPP, 3GPP2, WIMAX, WiFi and WLAN. In various embodiments of the invention, the four cellular Tx/Rx 174a, 174b, 174c and 174d and the four cellular antennas 172a, 172b, 172c and 172c may communicate utilizing different wireless communication standards and/or different frequency bands.

In operation, one or more femtocells comprising Tx/Rx 154a, 154b, 154c and 154d and corresponding femtocell antennas 152a, 152b, 152c and 152d may communicate replicas of the same information based on different wireless communication standards to the cellular enabled device 190. In this regard, the cellular enabled device 170 may be operable to receive the replicas of the same information in parallel based on the plurality of wireless communication standards via Tx/Rx 174a, 174b, 174c and 174d and the cellular antennas 172a, 172b, 172c and 172c. In this regard, the cellular enabled device 190 may be operable to select portions of information and/or combine information from the plurality of received signals based on a quality of received information and/or a relative quality of the received signal.

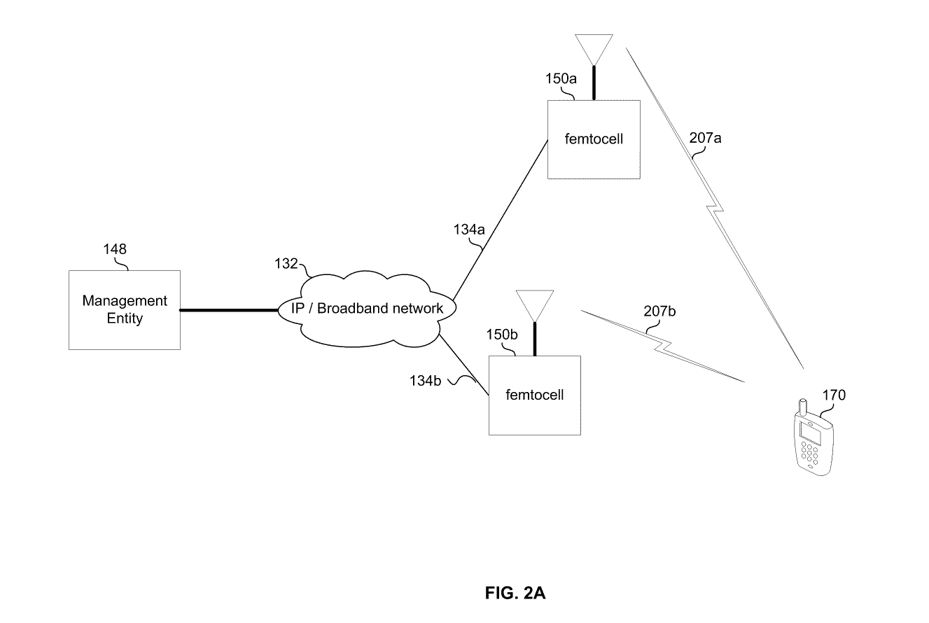

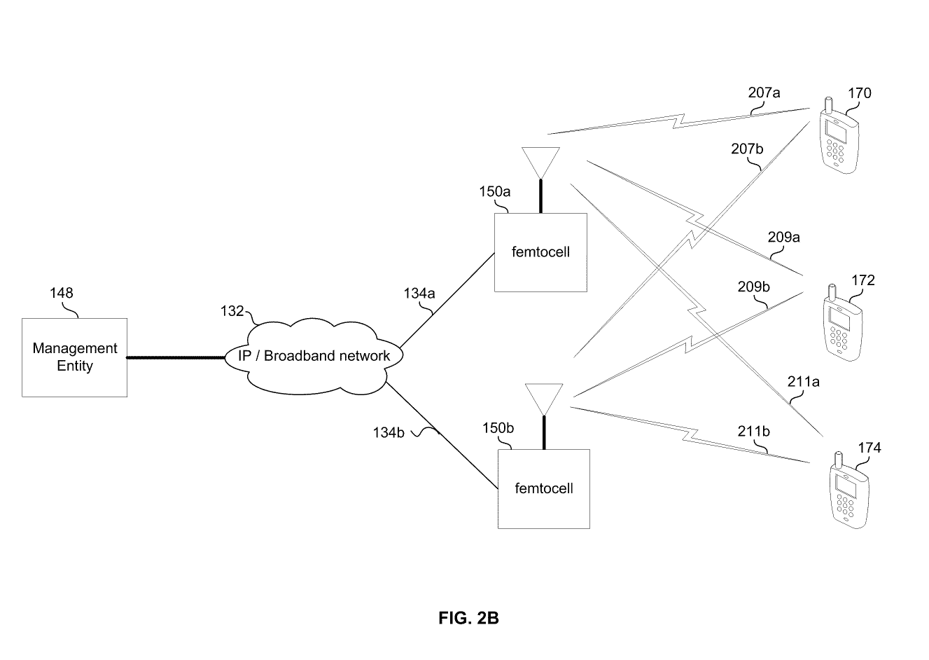

FIG. 2A is a diagram illustrating a plurality of femtocells transmitting the same information with transmit diversity to a single cellular enabled device, in accordance with an embodiment of the invention. Referring to FIG. 2A, there is shown the network management entity 148, the IP network 132, femtocells 150a and 150b, the cellular enabled device 170, connections 134a and 134b and cellular connections 207a and 207b.

The network management entity 148, may be similar to or the same as the network management entity 148 described with respect to FIG. 1B. The femtocells 150a and 150b may be similar to or the same as the femtocell 150 described with respect to FIG. 1C. The cellular enabled device 170 may be similar to or the same as the cellular enabled device 170 described with respect to FIG. 1D. The IP network 132 may be similar to or the same as the IP network 132 described with respect to FIG. 1B. The connections 134a and 134b may be similar to or the same as the connection 134 described with respect to FIG. 1B.

In operation, one or more of the femtocells 150a and 150b may be located within range of the cellular enabled device 170. For example, the femtocells 150a and 150b may be installed in the same building or in close proximity out of doors. The femtocells 150a and 150b may be operable to communicate simultaneously to the cellular enabled device 170 on the same call and/or session via the communication channels 207a and 207b respectively. In this regard, the femtocells 150a and 150b may engage simultaneously on a call and/or session with the cellular enabled device 170 wherein the same information may be transmitted to the cellular enabled device 170 from both of the femtocells 150a and 150b. Because the femtocells 150a and 150b communicate utilizing transmit diversity on a forward link, improvements in operating performance may result. For example, reliability of signal reception at the cellular enabled device 170 as well as a reduction of transmit power from one or more of the femtocells 150a and 150b may result from utilizing transmit diversity on the forward link.

In various embodiments of the invention, the femtocells 150a and 150b may establish in parallel a call and/or session with the cellular enabled device 170. In other embodiments of the invention, one of the femtocells may first establish a call and/or session with the cellular enabled device 170 and the other femtocell may be added to the established call and/or session. Furthermore, one or more of the femtocell 150a, the femtocell 150b, the network management entity 148 and the cellular enabled device 170 may be operable to coordinate communication between the femtocells 150a and 150b and the cellular enabled device 170. For example, the coordination may comprise initiating connections, synchronizing the femtocells 150a and 150b, adjusting transmission times to compensate for varying path lengths and path delays and adjusting transmitter power levels for optimizing receive signal levels at the cellular enabled device 170. In this manner, the femtocell 150a and 150b may be simultaneously engaged on a call and/or communication session with the cellular enabled device 170. In various embodiments of the invention, the cellular enabled device 170 may be operable to receive signals via the channels 207a and/or 207b and a rake receiver that may combine signals received from femtocells 150a and/or 150b.

In other embodiments of the invention, synchronized signal transmissions from femtocells 150a and 150b may be constructively combined “over-the-air” such that a more robust signal is received. In various embodiments of the invention, femtocells 150a and 150b may communicate via different wireless standards to the cellular enabled device 170. In this regard, the cellular enabled device 170 may be operable to receive the same information from one or more femtocells 150a and 150b that may utilize different wireless standards. The cellular enabled device may be operable to select portions of information and/or combine information from the plurality of received signals based on the quality of received information and/or the quality of the received signal. In various embodiments of the invention, one or more of the femtocells may be replaced with a microcell or macrocell, for example, the cellular base station 102 described with respect to FIG. 1.

FIG. 2B is a diagram illustrating a plurality of femtocells communicating with transmit diversity to a plurality of cellular enabled devices, in accordance with an embodiment of the invention. Referring to FIG. 2B, there is shown the network management entity 148, the IP network 132, femtocells 150a and 150b, the cellular enabled devices 170, 172 and 174, connections 134a and 134b and cellular connections 207a, 207b, 209a, 209b, 211a and 211b.

The network management entity 148, femtocells 150a and 150b, cellular enabled device 170, IP network 132, connections 134a and 134b may be similar to or the same as the system described with respect to FIG. 2A. The cellular enabled devices 172 and 174 and corresponding cellular channels 209a, 209b, 211a and 211b may be described in the same way as the cellular enabled device 170 and cellular channels 207a and 207b.

In operation, one or more of the femtocells 150a and 150b may be located in close proximity to a plurality of cellular enabled devices 170, 172 and 174. For example, the femtocells 150a and 150b may be installed in the same building or in close proximity out of doors. The femtocells 150a and 150b may be operable to communicate simultaneously with the cellular enabled device 170 via the communication channels 207a and 207b respectively, with the cellular enabled device 172 via the communication channels 209a and 209b respectively and with the cellular enabled device 174 via the communication channels 211a and 211b respectively. In this manner, the femtocells may communicate with transmit diversity on the forward link to each of the plurality of cellular enabled devices 170, 172 and 174. The transmit diversity may, for example, improve reliability of signal reception at the plurality of cellular enabled devices 170, 172 and 174 as well as enable a reduction of transmit power from one or more of the femtocells 150a and 150b.

The establishment of calls and/or sessions between the femtocells 150a and 150b and the individual cellular enabled devices 170, 172 and 174 may proceed in the same manner as the establishment of a call and/or session described with respect to FIG. 2A. Furthermore, one or more of the femtocell 150a, the femtocell 150b, the network management entity 148 and each the cellular enabled devices 170, 172 and 174 may be operable to coordinate communication between the femtocells 150a and 150b and the individual cellular enabled devices 170, 172 and 174. For example, the coordination may comprise initiating connections, synchronizing the femtocells 150a and 150b, adjusting transmission times to compensate for varying path lengths and path delays, adjusting transmitter power levels for optimizing receive signal levels. In this regard, the femtocell 150a and 150b may transmit and/or receive the same information to and/or from the cellular enabled device 170, the femtocell 150a and 150b may transmit and/or receive the same information to and/or from the cellular enabled device 172 and the femtocell 150a and 150b may transmit and/or receive the same information to and/or from the cellular enabled device 174.

In various embodiments of the invention, the cellular enabled devices 170, 172 and/or 174 may be operable to receive signals via the channels 207a and/or 207b, 209a and/or 209b and 211a and/or 211b respectively a rake receiver that may combine signals received from femtocells 150a and/or 150b. In other embodiments of the invention, synchronized signal transmissions from femtocells 150a and 150b may be constructively combined “over-the-air” such that a more robust signal is received. In various embodiments of the invention, femtocells 150a and 150b may communicate via different wireless standards to the cellular enabled device 170, 172 and/or 174. In this regard, the cellular enabled devices 170, 172 and 174 may be operable to receive the same information from one or more femtocells 150a and 150b that may utilize different wireless standards. The multimode cellular enabled devices may be operable to select portions of information and/or combine information from the plurality of received signals based on the quality of received information and/or the quality of the received signal. In various embodiments of the invention, one of the femtocells may be replaced with a microcell or macrocell, for example, the cellular base station 102 described with respect to FIG. 1.

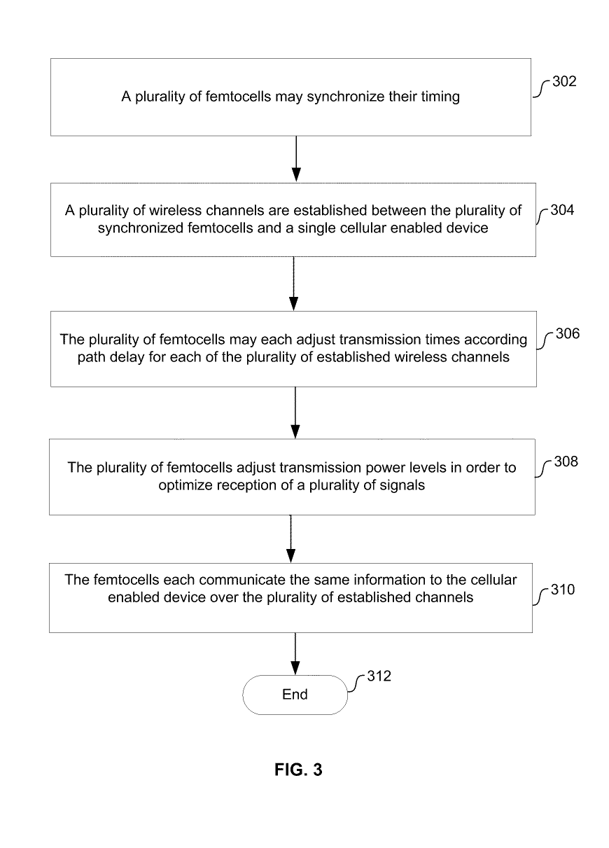

FIG. 3 illustrates exemplary steps for communicating the same information from two femtocells to a single cellular enabled device, in accordance with an embodiment of the invention. Referring to FIG. 3, the exemplary steps may begin with step 302 when a plurality of femtocells, for example, femtocells 150a and 150b may synchronize their timing. Subsequent to step 302, the exemplary steps may advance to step 304.

In step 304, a plurality of wireless channels may be established between the plurality of synchronized femtocells 150a and 150b and a single cellular enabled device 170. Subsequent to step 304, the exemplary steps may advance to step 306. In step 306, the plurality of femtocells 150a and 150b may each adjust transmission times according path delay for each of the plurality of established wireless channels 207a and 207b. Subsequent to step 306, the exemplary steps may advance to step 308. In step 308, the plurality of femtocells 150a and 150b may adjust transmission power levels in order to optimize reception of a plurality of signals. Subsequent to step 308, the exemplary steps may advance to step 310. In step 310 the femtocells 150a and 150b may each communicate the same information to the cellular enabled device 170 over the plurality of established channels 270. Step 312 may be an end of exemplary steps.

In various embodiments of the invention, a cellular enabled device 170 may be operable to receive replicas of content communicated from a plurality of femtocells, for example 110c and 110d. The replicas of the content may be transmitted by the plurality of femtocells 110c and 110d via transmit diversity wherein the content may comprise voice, video and/or data. In various embodiments of the invention, a location of the cellular enabled device 170 may be determined and/or communicated to each of the plurality of femtocells 110c and/or 110d. The femtocells 110c and 110d may be synchronized to enable the transmission of the content replicas based on the location of the cellular enabled device 170. In this manner, transmission times of the content replicas may be adjusted based on a location of the cellular enabled device 170. For example, the transmission times may be adjusted so that signals comprising the replicated content may combine coherently “over the air’ or within the cellular enabled device 170. Furthermore, the power and/or gain of the content replicas that are transmitted from each of the plurality of femtocells 110c and 110d may be adjusted based on the location of the cellular enabled device. In various embodiments of the invention, the content replicas may be received based on a plurality of wireless communication standards.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for high reliability delivery of content to a plurality of users via a plurality of femtocells.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
receiving via a cellular enabled device, replicas of content communicated from a plurality of femtocells, wherein each of said plurality of femtocells is operable to transmit said replicas of said content to said receiving cellular enabled device.

2. The method according to claim 1, wherein said content comprises voice, video and/or data.

3. The method according to claim 1, comprising determining a location of said cellular enabled device.

4. The method according to claim 3, comprising communicating said determined location of said cellular enabled device to said each of said plurality of femtocells.

5. The method according to claim 1, wherein said each of said plurality of femtocells are synchronized.

6. The method according to claim 1, comprising adjusting a transmission time of said replicas of said content transmitted from said each of said plurality of femtocells based on a location of said cellular enabled device.

7. The method according to claim 1, comprising adjusting a power and/or gain of said replicas of said content transmitted from said each of said plurality of femtocells based on a location of said cellular enabled device.

8. The method according to claim 1, wherein said each of said plurality of femtocells are synchronized to enable said transmission of said replicas of said content based on a location of said cellular enabled device.

9. The method according to claim 1, wherein said each of said plurality of femtocells enable said transmission of said replicas of said content to said receiving cellular enabled device via transmit diversity.

10. The method according to claim 1, comprising receiving said replicas of said content by said receiving cellular enabled device via different wireless communication standards.

11. A system for communication, the system comprising:
one or more circuits for use in a cellular enabled device, said one or more circuits is operable to receive replicas of content communicated from a plurality of femtocells, wherein each of said plurality of femtocells is operable to transmit said replicas of said content to said receiving cellular enabled device.

12. The system according to claim 11, wherein said content comprises voice, video and/or data.

13. The system according to claim 11, wherein said one or more circuits are operable to determine a location of said cellular enabled device.

14. The system according to claim 13, wherein said one or more circuits are operable to communicate said determined location of said cellular enabled device to said each of said plurality of femtocells.

15. The system according to claim 11, wherein said each of said plurality of femtocells are synchronized.

16. The system according to claim 11, wherein said one or more circuits are operable to adjust a transmission time of said replicas of said content transmitted from said each of said plurality of femtocells based on a location of said cellular enabled device.

17. The system according to claim 11, wherein said one or more circuits are operable to adjust a power and/or gain of said replicas of said content transmitted from said each of said plurality of femtocells based on a location of said cellular enabled device.

18. The system according to claim 11, wherein said each of said plurality of femtocells are synchronized to enable said transmission of said replicas of said content based on a location of said cellular enabled device.

19. The system according to claim 11, wherein said each of said plurality of femtocells enable said transmission of said replicas of said content to said receiving cellular enabled device via transmit diversity.

20. The system according to claim 11, wherein said one or more circuits are operable to receive said replicas of said content by said receiving cellular enabled device via different wireless communication standards.
